(19) United States
(12) Patent Application Publication
(10) Pub. No.: US 2008/0265447 A1
(43) Pub. Date: Oct. 30, 2008

(54) METHOD OF INPRINTING PATTERNS AND METHOD OF MANUFACTURING A DISPLAY SUBSTRATE BY USING THE SAME

(75) Inventor: Jung-Mok BAE, Seoul (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/034,800

(22) Filed: Feb. 21, 2008

(30) Foreign Application Priority Data
Apr. 30, 2007 (KR) 10-2007-0041769

(51) Int. Cl. B29C 43/02

(52) U.S. Cl. 264/1.1; 264/319

(57) ABSTRACT

A method of imprinting patterns, which is capable of enhancing the arrangement accuracy of a mold. The method includes spreading a resin on a substrate, temporarily compressing a mold toward the substrate having the resin spread thereon, moving the mold and the substrate relative to each other to arrange the mold and the substrate with respect to each other, compressing the mold toward the substrate, and curing the resin

This application claims priority to Korean Patent Application No. 2007-41769, filed on Apr. 30, 2007, and all the benefits accruing therefrom under 35 U.S.C. §119, the contents of which in its entirety are herein incorporated by reference.

### BACKGROUND OF THE INVENTION

1. Field of the Invention

The present invention relates to a method of imprinting patterns and a method of manufacturing a display substrate by using the same. More particularly, the present invention relates to a method of imprinting patterns, which is capable of enhancing an arrangement accuracy of a mold, and a method of manufacturing a display substrate by using the method of imprinting the resin.

2. Description of the Related Art

Recently, a method for printing a minute nanoscale pattern without an exposure process has been developed to be employed by not only a semiconductor technology but also a liquid crystal display (“LCD”) technology.

Conventionally, the method may be classified as either a hard type mold imprint method or a soft type mold imprint method according to a mold. The hard type mold imprint method is used for forming a small-sized device such as a semiconductor device, and the soft type mold imprint method is used for forming a large-sized device such as an LCD device.

The soil type mold may be used, even when a surface of substrate is not flat due to a structure such as wirings formed thereon. Therefore, the soft type mold is very useful.

A conventional soft type mold imprint method is as follows. A soft type mold is arranged with respect to a substrate having resin coated thereon. The soft type mold is compressed toward the substrate, and the resin is cured. However, as the size of the substrate increases for large sized display panels, the soft type mold also increases in size. Therefore, when the soft type mold is arranged with respect to the substrate, the soft type mold may sag, so that it is very hard and requires much time to accurately arrange the soft type mold with respect to the substrate.

### BRIEF SUMMARY OF THE INVENTION

The present invention has made an effort to solve the above-stated problem, and an aspect of the present invention provide a method of imprinting patterns, which is capable of enhancing the arrangement accuracy of a mold.

Another aspect of the present invention provides a method of manufacturing a display substrate by using the above-mentioned method of imprinting the resin.

The above and other aspects of the present invention will become apparent to one of ordinary skill in the art to which the present invention pertains by referencing the detailed description of the present invention given below.

In an exemplary embodiment, the present invention, provides a method of imprinting patterns, the method including, spreading a resin on a substrate, temporarily compressing a mold toward the substrate having the resin spread thereon, moving the mold and the substrate relative to each other to arrange the mold and the substrate with respect to each other, compressing the mold toward the substrate, and curing the resin.

According to an exemplary embodiment, the mold includes a soft type mold.

According to an exemplary embodiment, the soft type mold includes polyurethane acrylate (PUA) or poly-dimethyl siloxane (PDMS).

According to an exemplary embodiment, the mold is temporarily compressed toward the substrate such that the mold is separated from the substrate by a separation distance.

According to an exemplary embodiment, the first separation distance is in a range of approximately 10 micrometers (μm) to 100 μm.

According to an exemplary embodiment, temporarily compressing toward the substrate having the resin spread thereon includes, disposing a roller on a first side of the mold, and rolling the roller toward a second side of the mold which is opposite to the first side.

According to an exemplary embodiment, the roller includes a length which is longer than the first and second sides of the mold.

According to an exemplary embodiment, temporarily compressing the mold toward the substrate having the resin spread thereon includes compressing an entire upper surface of the mold simultaneously.

According to an exemplary embodiment, moving the mold and the substrate relative to each other to arrange the mold and the substrate with respect to each other includes allowing a first overlay mark formed on the substrate to coincide with a second overlay mark formed on the mold.

According to an exemplary embodiment, moving the mold and the substrate relative to each other to arrange the mold and the substrate with respect to each other includes fixing the substrate and moving the mold with respect to the substrate.

Alternatively, according to another exemplary embodiment, moving the mold and the substrate relative to each other to arrange the mold and the substrate with respect to each other includes fixing the mold and moving the substrate with respect to the mold.

According to an exemplary embodiment, the mold is compressed toward the substrate such that the mold makes contact with the substrate, when the mold is compressed toward the substrate.

According to an exemplary embodiment, compressing the mold toward the substrate includes disposing a roller on a first side of the mold, and rolling the roller toward a second side of the mold which is opposite to the first side.

According to an exemplary embodiment, compressing the mold toward the substrate includes compressing an entire upper surface of the mold simultaneously.

According to an exemplary embodiment, curing the resin includes irradiating ultraviolet light onto the resin. Alternatively, according to another exemplary embodiment, curing the resin includes applying heat to the resin.

In another exemplary embodiment, the present invention provides a method of manufacturing a display substrate, the method including spreading a resin on a substrate including a gate line, a source line and a switching element formed thereon. The switching clement includes a gate electrode electrically connected to the gate line, a source electrode electrically connected to the source line, and a drain electrode separated from the source is electrode. The method further includes temporarily compressing a mold including a protrusion toward the substrate having the resin spread thereon, moving the mold and the substrate relative to each other to arrange the mold and the substrate with respect to each other such that the protrusion of the mold is disposed on the drain electrode, compressing the mold toward the substrate such that the protrusion of the mold makes contact with the drain electrode, and curing the resin.

According to an exemplary embodiment, the method further includes forming a transparent and conductive layer on the resin which is cured such that the transparent and conductive layer is electrically connected through a contact hole formed by the protrusion of the mold, and patterning the transparent and conductive layer to form a transparent electrode.

According to an exemplary embodiment, the mold includes a plurality of embossing patterns having a height which is lower than the height of the protrusion.

According to an exemplary embodiment, the method further includes forming a transparent and conductive layer on the resin which is cured such that the transparent and conductive layer is electrically connected through a contact hole formed by the protrusion of the mold, patterning the transparent and conductive layer to form a transparent electrode., forming a metal layer on the transparent electrode, and patterning the metal layer to form a reflective electrode.

Therefore, according to an exemplary embodiment, the arrangement accuracy of the mold is enhanced.

### BRIEF DESCRIPTION OF THE DRAWINGS

The above and/or other aspects, features and advantages of the present invention will become more apparent from the following detailed description when taken in conjunction with the accompanying drawings, in which:

FIG. 1 is a flow chart illustrating an exemplary embodiment of a method of imprinting patterns according to the present invention;

FIG. 2 is a cross-sectional view illustrating an exemplary embodiment of a resin-spreading operation in FIG. 1 according to the present invention;

FIG. 3 is a cross-sectional view illustrating an exemplary embodiment of a mold-arranging operation in FIG. 1 according to the present invention;

FIG. 4 is a cross-sectional view illustrating an exemplary embodiment of a compressing operation in FIG. 1 according to the present invention; and

FIGS. 5A through 5F are cross-sectional views illustrating an exemplary embodiment of a method of manufacturing a display substrate according to the present invention.

### DETAILED DESCRIPTION OF THE INVENTION

The present invention will now described more fully hereinafter with reference to the accompanying drawings, in which embodiments of the invention are shown. The invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from an implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

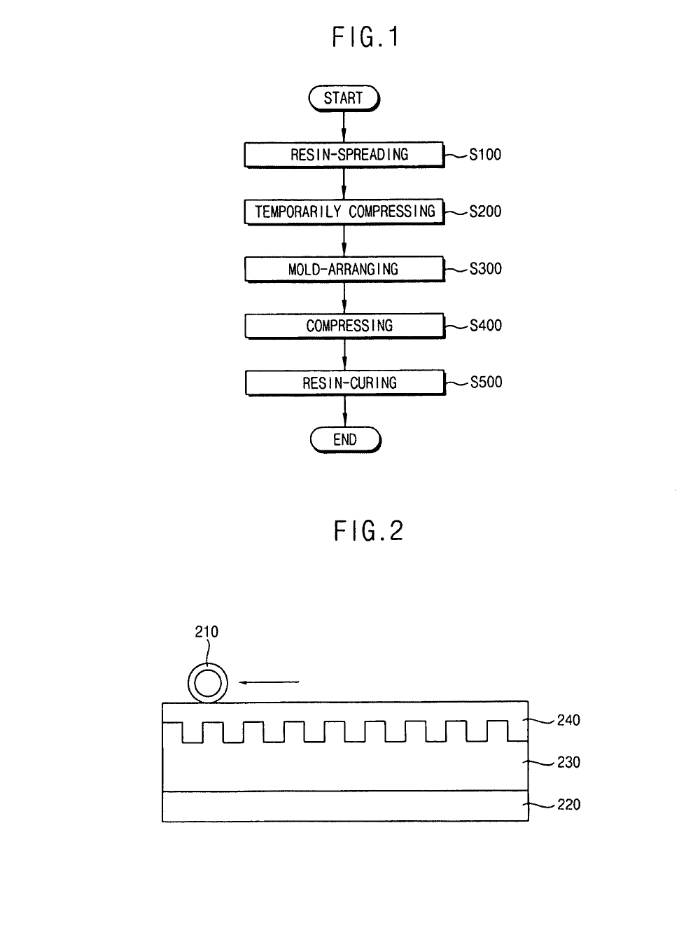

FIG. 1 is a flow chart illustrating an exemplary embodiment of a method of implanting resin according to the present invention.

According to an exemplary embodiment of a method of the present invention, at operation S100, a resin is spread on a substrate. According to an exemplary embodiment, a surface of the substrate may be flat or the surface of the substrate may not be flat.

Further, as shown in FIG. 1, at operation S200, a mold is temporarily compressed toward the substrate having the resin spread thereon. According to an exemplary embodiment, in the temporarily compressing operation (operation S200), the mold is not yet arranged with respect to the substrate.

From operation S200, the process moves to operation S300 where either the mold or the substrate is moved along a horizontal direction with respect to each other, so that the mold and the substrate are arranged with respect to each other.

Then, the process moves to operation S400 where the mold is compressed toward the substrate, and operation S500 where the resin is cured.

Hereinafter, each operation will be explained in detail, referring to figures.

FIG. 2 is a cross-sectional view illustrating an exemplary embodiment of a resin-spreading operation in FIG. 1.

Referring to FIG. 2, when a resin 230 is spread on a substrate 220, the mold 240 is moved to be disposed on the resin 230. Then, the mold 240, which is not arranged with respect to the substrate 220, is temporarily compressed toward the substrate 220 having the resin 230 spread thereon.

According to an exemplary embodiment, the terminology “temporarily compress” means not only an artificial compress of the mold 240 toward the substrate 220 having the resin 230 spread thereon, but also a natural compress of the mold toward the substrate 220 having the resin 230 spread thereon due to the weight of the mold 240. That is, the terminology “temporarily compress” means a state in which the resin 230 supports the mold 240.

According to an exemplary embodiment, the mold 240 comprises a soft type mold. The soft type mold includes polymer. For example, according to an exemplary embodiment, the soft type mold includes elastomer. According to an exemplary embodiment, the soft type mold includes polyurethane acrylate (“PUA”), poly-dimethyl siloxane (“PDMS”), etc.

According to an exemplary embodiment, the soft type mold may be applied to a substrate 220 having a non-flat surface due to a structure such as wirings formed on the substrate 220.

There are several advantages for using PUA and PDMS.

According to an exemplary embodiment, the mold including PUA or PDMA may stably make contact with a substrate having relatively large area. Furthermore, the mold including PUA or PDMA may be applied to a substrate of which surface is not flat.

Further, a surface of the mold has a relatively low interface free energy. Therefore, resin including polymer may be easily separated from the mold including PUA or PDMS.

In addition, PUA and PDMS are homogeneous, isotropic and optically transparent to some extent of thickness.

Also, PUA and PDMS have high durability. Therefore, the mold including PUA or PDMS may be used relatively many times.

According to an exemplary embodiment, when compressing the mold 240 toward the resin 230, the mold 240 is compressed such that the mold 240 is separated from the substrate 220. For example, the mold 240 is compressed toward the substrate 220 such that the mold 240 is separated from the substrate 220 by a separation distance of approximately 10 micrometers (μm) to 100 μm. When the mold 240 is compressed such that the separation distance is too small (for example less than approximately 10 μm), the relative movement of the mold 240 and the substrate 220 is not smooth. On the contrary, when the mold 240 is compressed such that the separation distance is too large (for example more than approximately 100 μm), the amount of wasted resin increases.

When the mold 240 is temporarily compressed toward the resin 230, a roller 210 may be employed. According to an exemplary embodiment, the roller 210 rolls on the mold 240 from a first side of the mold 240 to a second side of the mold 240 which is opposite to the first side. According to an exemplary embodiment, a length of the roller 210 is substantially equal to or larger than a length of the first and second sides of the mold 240. When the length of the roller 210 is substantially equal to or larger than the length of the first and second sides of the mold 240, a thickness of the resin 230 may be uniform throughout all regions of the mold 240 during the temporarily compressing operation (operation S200).

Instead of using the roller 210 in the temporary compression operation (operation S200), according to an exemplary embodiment, the entire upper surface of the mold 240 may be simultaneously compressed. In the temporary compression operation (operation S200), the mold 240 may move toward the substrate 220 or the substrate 220 may move toward the mold 240.

FIG. 3 is a cross-sectional view illustrating an exemplary embodiment of a mold-arranging operation in FIG. 1 according to the present invention.

Referring to FIG. 3, when the mold 240 is temporarily compressed toward the substrate 220 with the resin 230 disposed between the mold 240 and the substrate 220, the mold 240 and the substrate 220 move relative to each other to arrange the mold 240 and the substrate 220 with respect to each other. In the mold-arranging operation (operation S300), the resin 230 supports the mold 240 to prevent sagging of the mold 240. Therefore, the mold 240 and the substrate 220 may be more accurately arranged with respect to each other. According to an exemplary embodiment, then the mold 240 and the substrate 220 are moved relative to each other, the resin 230 operates as a lubricant.

According to an exemplary embodiment, in the mold-arranging operation (operation S300), the substrate 220 may be fixed and the mold 240 may move. Alternatively, according to another exemplary embodiment, the mold 240 may be fixed and the substrate 220 may move.

According to an exemplary embodiment, when a supporting plate 260 vacuum absorbs the substrate 220, the substrate 220 is fixed to the supporting plate 260. The mold 240 is fixed to a transferring apparatus (not shown) by a clamp 250. When the substrate 220 is fixed to the supporting plate 260, the transferring apparatus moves the mold 240 along a horizontal direction that is substantially parallel with a surface of the supporting plate 260.

On the contrary, according to another exemplary embodiment, the mold 240 may be fixed by the clamp, and the supporting plate 260 may move to arrange the mold 240 and the substrate 220 with respect to each other.

According to an exemplary embodiment, by allowing a first overlay mark (not shown) formed on the substrate 220 to coincide with a second overlay mark (not shown) formed on the mold 240, the mold 240 and the substrate 220 are arranged with respect to each other.

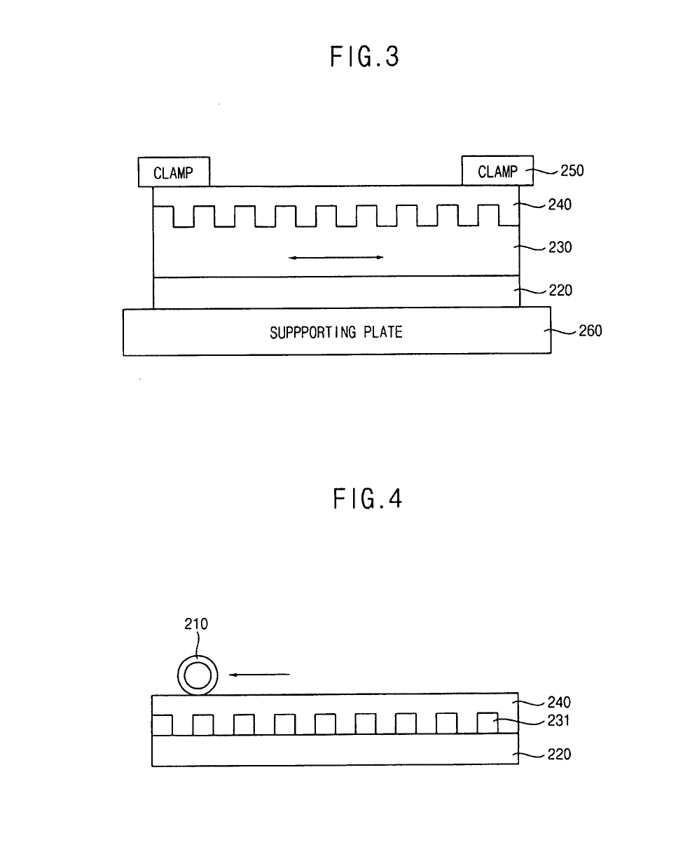

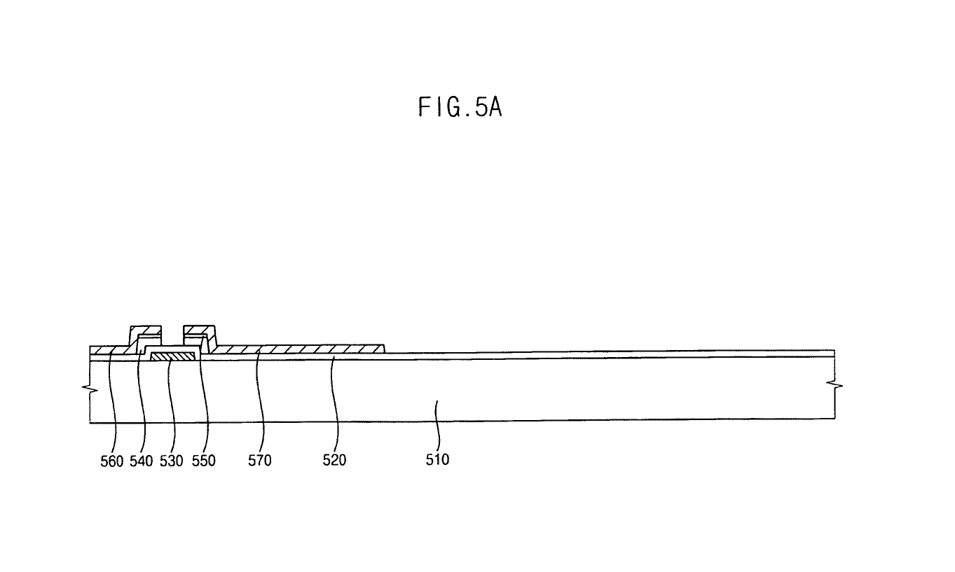

FIG. 4 is a cross-sectional view illustrating an exemplary embodiment of a compressing operation in FIG. 1 according to the present invention.

Referring to FIG. 4, the roller 210 rolls on the mold 240 from the first side of the mold 240 to the second side of the mold 240 to compress the mold 240 toward the substrate 220. Unlike the temporarily compressing operation (operation S200), the mold 240 is compressed such that the mold 240 makes contact with the substrate 220. Then, only a portion 231 of resin 230, which is disposed in a groove of the mold 240, remains to form a pattern.

In the compressing operation (operation S400), instead of using the roller 210, according to an exemplary embodiment, an entire upper surface of the mold 240 may be simultaneously compressed. In the compressing operation (operation S400), according to an exemplary embodiment, the mold 240 may move toward the substrate 220 or the substrate 220 may move toward the mold 240.

Then, according to an exemplary embodiment, an ultraviolet (UV) light may be irradiated onto the resin 230 to cure the resin 230 (operation S500). When the resin 230 is cured, the mold 240 is separated from the substrate 220.

According to another exemplary embodiment, the resin 230 is cured by heat, which is applied to the resin 230 instead of UV light.

The method of imprinting the resin described above may be applied to various industrial fields. According to an exemplary embodiment, the method of imprinting the resin may be applied to a process of manufacturing a flat panel display device. Hereinafter, an application of the method to a process of manufacturing a flat panel display device will be explained.

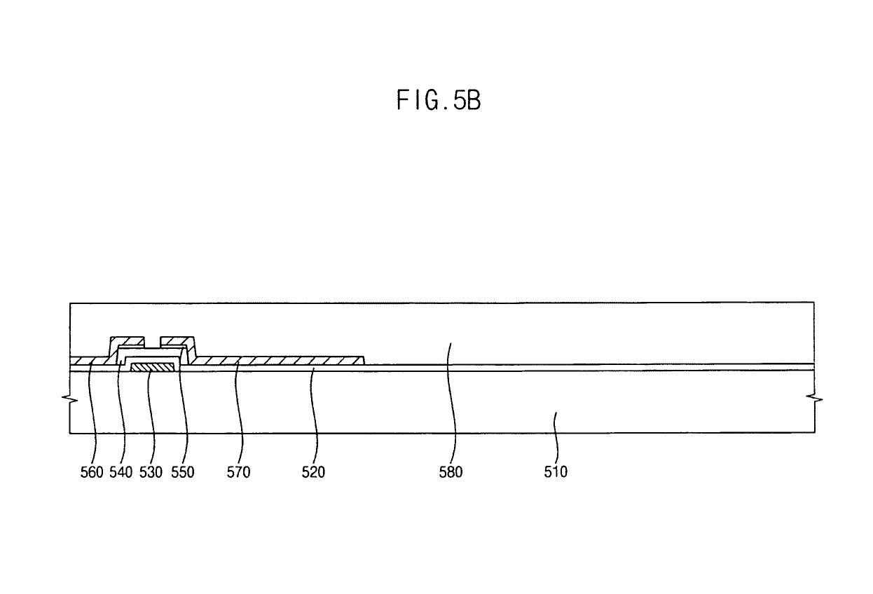

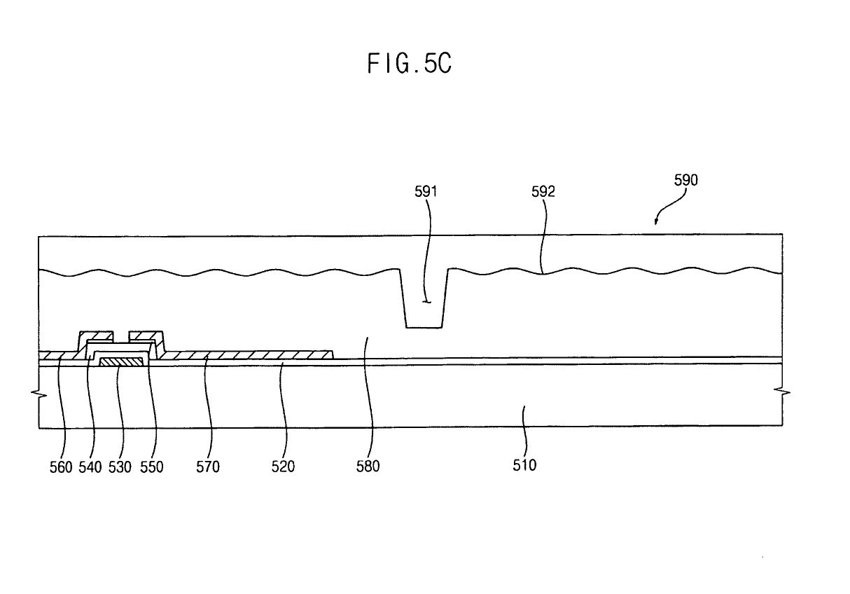

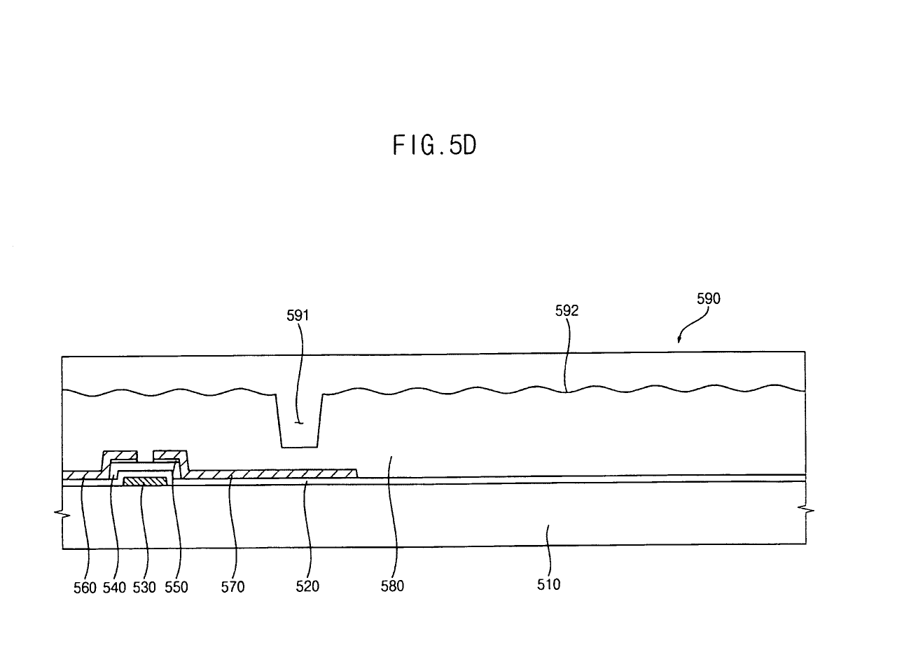

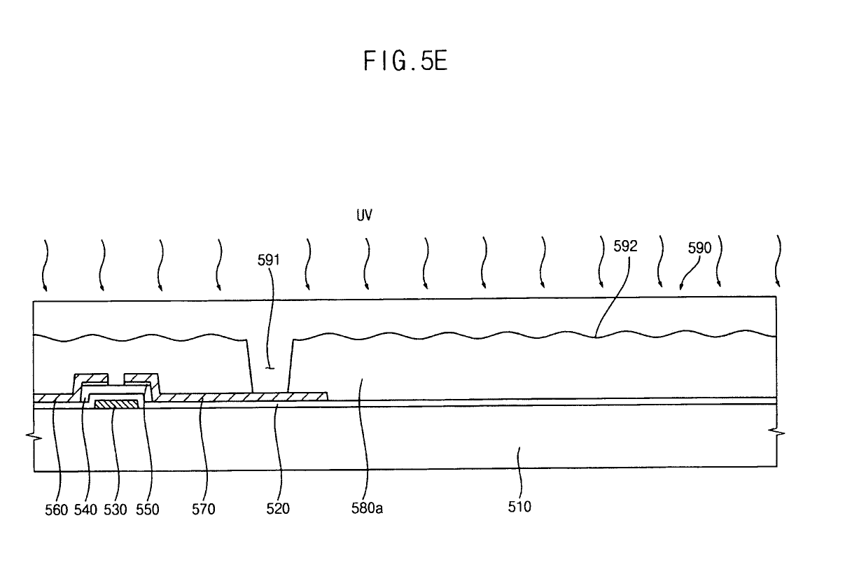

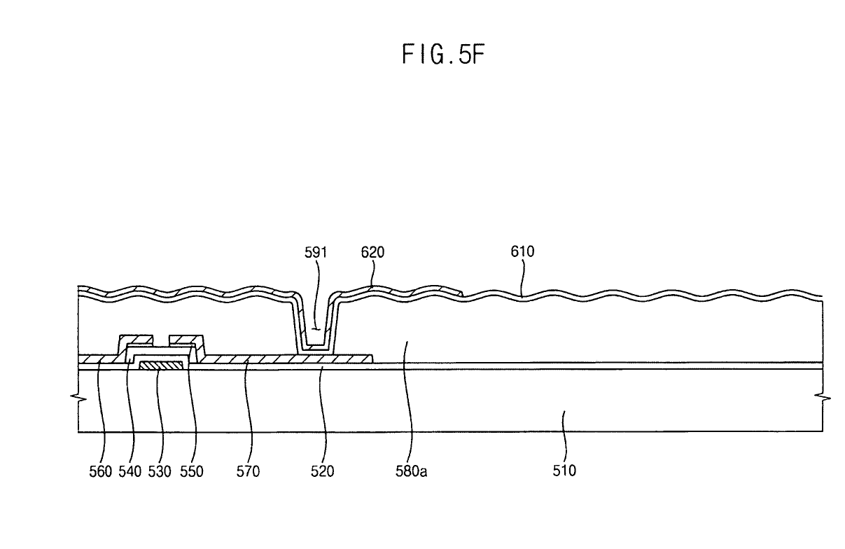

FIGS. 5A through 5F are cross-sectional views illustrating an exemplary embodiment of a method of manufacturing a display substrate according to the present invention.

Referring to FIG. 5A, according to an exemplary embodiment, a gate metal layer (not shown) is formed on a substrate 510, for example, through a sputtering method, a chemical vapor deposition (“CVD”) method, etc., and the gate metal layer is patterned to form a gate line (not shown) and a gate electrode 530 electrically connected to the gate line. Then, a gate insulation layer 520 is formed on the substrate 510. An active pattern 540 and an ohmic contact pattern 550 are formed on the gate insulation layer 520.

Then, a source metal layer (not shown) is formed on the substrate 510 having the active pattern 540 and the ohmic contact pattern 550 formed thereon, for example, through a sputtering method and a CVD method. Then, the source metal layer is patterned to form a source line (not shown), a source electrode 560 electrically connected to the source line, and a drain electrode 570 separated from the source electrode 560.

Referring to FIG. 5B, according to an exemplary embodiment, a resin 580 is spread on the substrate 510 including the gate line, the source line and a switching element defined by the gate electrode 530 electrically connected to the gate line, the source electrode 560 electrically connected to the source line, and the drain electrode separated from the source line.

Referring to FIG SC, according to an exemplary embodiment, a mold 590 temporarily compresses the substrate 510 having the resin 580 spread thereon. The mold 590 includes a protrusion 591 and a plurality of embossing patterns 592. The embossing pattern 592 includes a smaller height than the protrusion 591.

Referring to FIG. 5D, according to an exemplary embodiment, the mold 590 and the substrate 510 move relative to each other to arrange the mold 590 and the substrate 510 with respect to each other such that the protrusion 591 is disposed over the drain electrode 570. When the mold 590 and the substrate 510 are arranged with respect to each other, the protrusion 591 is separated from the substrate 510.

Referring to FIG. 5E, according to an exemplary embodiment, the mold 590, which is arranged with respect to the substrate 510, is compressed toward the substrate 510, such that the protrusion 591 makes contact with the drain electrode 570.

Then, UV light is irradiated onto the resin 580 to cure the resin 580, and the mold 590 is separated from the substrate 510. As a result, an insulation layer 580a is formed.

The insulation layer 580a formed through the above-mentioned process includes a plurality of patterns formed by the embossing patterns 592 of the mold 590, and a contact hole exposing a portion of the drain electrode 570, which is formed by the protrusion 591 of the mold 590.

Referring to FIG. 5F, according to an exemplary embodiment, a transparent and conductive layer (not shown) is formed on the insulation layer 580a, and the transparent and conductive layer is patterned to form a transparent electrode 610. According to an exemplary embodiment, the transparent electrode 610 includes indium tin oxide (“ITO”), indium zinc oxide (“IZO”), etc.

The transparent electrode 610 is electrically connected to the drain electrode 570 exposed through the contact hole formed by the protrusion 591.

Then, a metal layer including metal of high reflectivity, such as chromium (Cr), nickel (Ni), etc. is formed on the substrate 510 having the transparent electrode 610 formed thereon, and the metal layer is patterned to form a reflective electrode 620. The patterns formed on the insulation layer 580a by the embossing patterns 592 of the mold 590 enhances reflectivity of the reflective electrode formed thereon.

Hereinbefore, the method of imprinting the resin of the present invention is applied to a process of forming a transflective LCD device. However, according to an exemplary embodiment, the method of imprinting the resin may be applied to a process of forming a contact hole of a transmissive LCD device. Additionally, the method of imprinting the resin may substitute the conventional photolithography process.

According to an exemplary embodiment, the method of the present invention enhances an arrangement accuracy of the mold.

While the present invention has been shown and described with reference to some exemplary embodiments thereof, it should be understood by those of ordinary skill in the art that various changes in form and details may be made therein without departing from the spirit and the scope of the present invention as defined by the appended claims.

What is claimed is:

1. A method of imprinting patterns, comprising:
spreading a resin on a substrate;
temporarily compressing a mold toward the substrate having the resin spread thereon;
moving the mold and the substrate relative to each other to arrange the mold and the substrate with respect to each other;
compressing the mold toward the substrate; and
curing the resin.

2. The method of claim 1, wherein the mold comprises a soft type mold.

3. The method of claim 2, wherein the soft type mold comprises polyurethane acrylate or poly-dimethyl siloxane.

4. The method of claim 1, wherein the mold is temporarily compressed toward the substrate such that the mold is separated from the substrate by a separation distance, in temporarily compressing a mold toward the substrate having the resin spread thereon.

5. The method of claim 4, wherein the separation distance is in a range of approximately 10 μm to 100 μm.

6. The method of claim 1, wherein temporarily compressing a mold toward the substrate having the resin spread thereon, comprises:
disposing a roller on a first side of the mold; and
rolling the roller toward a second side which is opposite to the first side.

7. The method of claim 6, wherein the roller comprises a length which is longer than the first and second sides of the mold.

8. The method of claim 1, wherein temporarily compressing a mold toward the substrate having the resin spread thereon comprises compressing an entire upper surface of the mold simultaneously.

9. The method of claim 1, wherein moving the mold and the substrate relative to each other to arrange the mold and the substrate with respect to each other comprises allowing a first overlay mark which is formed on the substrate to coincide with a second overlay mark which is formed on the mold.

10. The method of claim 1, wherein moving the mold and the substrate relative to each other to arrange the mold and the substrate with respect to each other, comprises:
fixing the substrate; and
moving the mold with respect to the substrate.

11. The method of claim 1, wherein moving the mold and the substrate relative to each other to arrange the mold and the substrate with respect to each other, comprises:
fixing the mold; and
moving the substrate with respect to the mold.

12. The method of claim 11, further comprises fixing the mold via a clamps and moving the substrate via a supporting plate to arrange the mold and the substrate with respect to each other.

13. The method of claim 1, wherein the mold is compressed toward the substrate such that the mold makes contact with the substrate, in compressing the mold toward the substrate.

14. The method of claim 13, wherein compressing the mold toward the substrate, comprises:
disposing a roller on a first side of the mold; and
rolling the roller toward a second side which is opposite to the first side.

15. The method of claim 13, wherein compressing a mold toward the substrate comprises compressing an entire upper surface of the mold simultaneously.

16. The method of claim 1, wherein curing the resin comprises irradiating ultraviolet light onto the resin.

17. The method of claim 1, wherein curing the resin comprises applying heat to the resin.

18. The method of claim 1, wherein the mold is not arranged with respect to the substrate when temporarily compressing the mold toward the substrate.

19. The method of claim 1, wherein moving the mold and the substrate relative to each other comprises moving one of the mold and the substrate along a horizontal direction with respect to each other, such that the mold and the substrate are arranged with respect to each other.

20. A method of manufacturing a display substrate, comprising:
spreading a resin on a substrate comprising a gate line, a source line and a switching element formed thereon, the switching element including a gate electrode electrically connected to the gate line, a source electrode electrically connected to the source line, and a drain electrode separated from the source electrode;
temporarily compressing a mold including a protrusion, toward the substrate having the resin spread thereon;
moving the mold and the substrate relative to each other to arrange the mold and the substrate with respect to each other such that the protrusion of the mold is disposed on the drain electrode;
compressing the mold toward the substrate such that the protrusion of the mold makes contact with the drain electrode; and
curing the resin.

21. The method of claim 20, further comprising:
forming a transparent and conductive layer on the resin that is cured such that the transparent and conductive layer is electrically connected through a contact hole formed by the protrusion of the mold; and
patterning the transparent and conductive layer to form a transparent electrode.

22. The method of claim 20, wherein the mold includes a plurality of embossing patterns including a height which is lower than a height of the protrusion.

23. The method of claim 20, further comprising:
forming a transparent and conductive layer on the resin that is cured such that the transparent and conductive layer is electrically connected through a contact hole formed by the protrusion of the mold;
patterning the transparent and conductive layer to form a transparent electrode;
forming a metal layer on the transparent electrode; and
patterning the metal layer to form a reflective electrode.
